(19) United States
(12) Patent Application Publication
(10) Pub. No.: US 2007/0068902 A1
(43) Pub. Date: Mar. 29, 2007

(54) Polishing composition and polishing method

(76) Inventors: Yasushi Matsunami, Gifu-shi (JP); Junichi Hirano, Nagoya-shi (JP); Jie Lin, Tualatin, OR (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/238,256

(22) Filed: Sep. 29, 2005

(51) Int. Cl. B44C 1/22; C09K 13/00; C03C 15/00

(52) U.S. Cl. 216/88; 252/79.1; 216/22

(57) ABSTRACT

A polishing composition contains abrasive grain such as colloidal silica, acid such as citric acid and orthophosphoric acid, an oxidizing agent such as hydrogen peroxide, a compound selected from a group consisting of azoles and its derivatives such as benzotriazole. The polishing composition is suitably used for polishing a magnetic disk substrate.

### BACKGROUND OF THE INVENTION

The present invention relates to a polishing composition that is used for polishing a magnetic disk substrate, and to a polishing method using the polishing composition.

The polishing composition used for polishing the magnetic disk substrate is required to, for example, form only a small number of scratches on the surface of the magnetic disk substrate, and polish the magnetic disk substrate at a high removal rate when the polishing composition is used to polish the magnetic disk substrate. For example, U.S. Pat. No. 6,818,031 discloses a polishing composition improved to satisfy those requirements. The polishing composition of U.S. Pat. No. 6,818,031 contains organic phosphonic acid to suppress generation of scratches when the magnetic disk substrate is polished using the polishing composition. However, the polishing composition of U.S. Pat. No. 6,818,031 does not sufficiently satisfy the required performance regarding scratches and the removal rate, and there is yet room for improvements in the polishing composition.

### SUMMARY OF THE INVENTION

Accordingly, it is an objective of the present invention to provide a polishing composition that is more suitable for use in polishing a magnetic disk substrate and a polishing method using the polishing composition.

To achieve the above objective, the present invention provides a polishing composition that contains abrasive grain, acid, an oxidizing agent, and a compound selected from a group consisting of azoles and its derivatives, and is used for polishing a magnetic disk substrate.

The present invention also provides a method for polishing a magnetic disk substrate. The method includes preparing the polishing composition, and polishing the magnetic disk substrate using the polishing composition.

### DETAILED DESCRIPTION OF THE PREFERRED EMBODIMENTS

One embodiment of the present invention will now be described.

A polishing composition of the preferred embodiment is manufactured by mixing abrasive grain, acid, an oxidizing agent, a compound selected from a group consisting of azoles and its derivatives, and water. Therefore, the polishing composition of the preferred embodiment substantially consists of abrasive grain, acid, the oxidizing agent, the compound selected from the group consisting of azoles and its derivatives, and water. The polishing composition is used for polishing a magnetic disk substrate. In other words, the polishing composition is used for polishing a semi-finished product of the magnetic disk substrate to obtain the magnetic disk substrate as a polished product. The polishing composition of the preferred embodiment is preferably used in the final polishing process (finish polishing process) among polishing processes generally performed during machining of the magnetic disk substrate.

The abrasive grain in the polishing composition plays the role of mechanically polishing the magnetic disk substrate, and improves the removal rate of the magnetic disk substrate with the polishing composition.

The abrasive grain in the polishing composition may be silica such as colloidal silica, fumed silica, and precipitated silica, or other than silica such as zirconia, alumina, ceria, and titania. However, the abrasive grain included in the polishing composition is preferably silica, and more preferably colloidal silica. When the abrasive grain included in the polishing composition is silica, or more specifically colloidal silica, scratches formed on the surface of the magnetic disk substrate are reduced when the magnetic disk substrate is polished using the polishing composition.

When the average particle size of the abrasive grain included in the polishing composition is less than 0.005 μm, and more specifically less than 0.01 μm, the removal rate of the magnetic disk substrate with the polishing composition is not significantly improved. Moreover, there is a risk that a polishing machine could vibrate because the abrasion resistance is excessively increased. Therefore, in view of improving the removal rate and reducing vibration of the polishing machine, the average particle size of the abrasive grain included in the polishing composition is preferably 0.005 μm or more, and more preferably 0.01 μm or more.

Contrastingly, when the average particle size of the abrasive grain included in the polishing composition is greater than 1 μm, there is a risk that scratches formed on the surface of the magnetic disk substrate could be increased, or the surface roughness of the magnetic disk substrate could be increased when the magnetic disk substrate is polished using the polishing composition. Therefore, in view of maintaining the surface quality of the magnetic disk substrate, the average particle size of the abrasive grain included in the polishing composition is preferably 1 μm or less. The average particle size of the abrasive grain is calculated based on the specific surface area of the abrasive grain measured through a BET method.

In particular, when the abrasive grain included in the polishing composition is colloidal silica, the following can be said about the average particle size of colloidal silica included in the polishing composition as the abrasive grain. That is, when the average particle size of colloidal silica included in the polishing composition as the abrasive grain is greater than 0.2 μm, and more specifically greater than 0.08 μm, there is a risk that colloidal silica in the polishing composition could easily precipitate. Furthermore, when the magnetic disk substrate is polished using the polishing composition, there is a risk that scratches formed on the surface of the magnetic disk substrate could be increased, or the surface roughness of the magnetic disk substrate could be increased. Therefore, in view of preventing colloidal silica from precipitating and further improving the surface quality of the magnetic disk substrate, the average particle size of the colloidal silica included in the polishing composition as the abrasive grain is preferably 0.2 μm or less, and more preferably 0.08 μm or less.

When the content of the abrasive grain in the polishing composition is less than 0.01% by mass, more specifically less than 0.1% by mass, and even more specifically less than 1% by mass, the removal rate of the magnetic disk substrate with the polishing composition is not significantly improved. Moreover, there is a risk that the polishing machine could vibrate because the abrasion resistance is excessively increased. Therefore, in view of improving the removal rate and reducing vibration of the polishing machine, the content of the abrasive grain in the polishing composition is preferably 0.01% by mass or more, more preferably 0.1% by mass or more, and most preferably 1% by mass or more. Contrastingly, when the content of the abrasive grain in the polishing composition is greater than 40% by mass, more specifically greater than 20% by mass, and even more specifically greater than 10% by mass, there is a risk that the abrasive grain could easily flocculate, which could easily precipitate in the polishing composition. Therefore, in view of preventing precipitation of the abrasive grain, the content of the abrasive grain in the polishing composition is preferably 40% by mass or less, more preferably 20% by mass or less, and most preferably 10% by mass or less.

Acid in the polishing composition plays the role of chemically polishing the magnetic disk substrate, and improves the removal rate of the magnetic disk substrate with the polishing composition.

Acid included in the polishing composition may be an organic acid, and more specifically, acid in the polishing composition may be organic carboxylic acid, organic phosphonic acid, or organic sulfonic acid the number of carbons of which is 1 to 10. Even more specifically, acid included in the polishing composition may be citric acid, maleic acid, maleic anhydride, malic acid, glycolic acid, succinic acid, itaconic acid, malonic acid, iminodiacetic acid, gluconic acid, lactic acid, mandelic acid, tartaric acid, crotonic acid, nicotinic acid, acetic acid, adipic acid, formic acid, oxalic acid, methyl acid phosphate, ethyl acid phosphate, ethyl glycol acid phosphate, isopropyl acid phosphate, phytic acid, 1-hydroxyethylidene-1,1-diphosphonic acid (abbrev. HEDP), or methanesulfonic acid. Among these acids, acid included in the polishing composition is preferably citric acid, maleic acid, malic acid, succinic acid, malonic acid, methyl acid phosphate, or HEDP, and more preferably maleic acid, or malonic acid. When acid included in the polishing composition is citric acid, maleic acid, malic acid, succinic acid, malonic acid, methyl acid phosphate, or HEDP, the removal rate of the magnetic disk substrate with the polishing composition is significantly improved. Among these acids, when acid included in the polishing composition is maleic acid or malonic acid, the removal rate of the magnetic disk substrate with the polishing composition is particularly significantly improved.

Acid included in the polishing composition may also be an inorganic acid, more specifically, acid included in the polishing composition may be phosphoric acid such as orthophosphoric acid, pyrophosphoric acid, polyphosphoric acid, metaphosphoric acid, and hexametaphosphoric acid, or may be phosphonic acid, sulfonic acid, or sulfuric acid. Among these acids, acid included in the polishing composition is preferably orthophosphoric acid or polyphosphoric acid. When acid included in the polishing composition is orthophosphoric acid or polyphosphoric acid, the removal rate of the magnetic disk substrate with the polishing composition is significantly improved.

When the content of acid in the polishing composition is less than 0.01% by mass, and more specifically less than 0.1% by mass, the removal rate of the magnetic disk substrate with the polishing composition is not significantly improved. Therefore, in view of improving the removal rate, the content of acid in the polishing composition is preferably 0.01% by mass or more, and more preferably 0.1% by mass or more. Contrastingly, when the content of acid in the polishing composition is greater than 40% by mass, and more specifically greater than 20% by mass, there is a risk that the corrosive effect of the polishing composition could become too strong. As a result, there is a risk that the surface of the magnetic disk substrate could be roughened, or the polishing machine could become susceptible to corrosion when the magnetic disk substrate is polished using the polishing composition. Therefore, in view of optimizing the corrosive effect, the content of acid in the polishing composition is preferably 40% by mass or less, and more preferably 20% by mass or less.

The oxidizing agent in the polishing composition oxidizes the surface of the magnetic disk substrate. When the surface of the magnetic disk substrate is oxidized by the oxidizing agent, mechanical polishing of the magnetic disk substrate with the abrasive grain is promoted. As a result, the removal rate of the magnetic disk substrate with the polishing composition is improved.

The oxidizing agent included in the polishing composition is preferably hydrogen peroxide to improve the removal rate of the magnetic disk substrate with the polishing composition and the stability of the polishing composition.

When the content of the oxidizing agent in the polishing composition is less than 0.1% by mass, and more specifically less than 0.3% by mass, the removal rate of the magnetic disk substrate with the polishing composition is not significantly improved. Therefore, in view of improving the removal rate, the content of the oxidizing agent in the polishing composition is preferably 0.1% by mass or more, and more preferably 0.3% by mass or more. Contrastingly, when the content of the oxidizing agent in the polishing composition is greater than 5% by mass, and more specifically greater than 1% by mass, there is a risk that the surface of the magnetic disk substrate could be roughened when the magnetic disk substrate is polished using the polishing composition. Therefore, in view of preventing the surface roughening, the content of the oxidizing agent in the polishing composition is preferably 5% by mass or less, and more preferably 1% by mass or less.

The compound selected from the group consisting of azoles and its derivatives included in the polishing composition reduces scratches formed on the surface of the magnetic disk substrate when the magnetic disk substrate is polished using the polishing composition. This effect is presumed to occur because a protective film is formed on the surface of the magnetic disk substrate by the compound selected from the group consisting of azoles and its derivatives. The azole derivatives are, for example, a substance in which a hydrogen atom bonded to a carbon atom or a nitrogen atom in a molecule of azoles is replaced with other atomic group.

The compound selected from the group consisting of azoles and its derivatives included in the polishing composition may be a compound selected from a group consisting of diazoles, triazoles, tetrazoles and their derivatives. More specifically, the compound selected from the group consisting of azoles and its derivatives included in the polishing composition may be a compound selected from a group consisting of benzotriazole, tolyltriazole, 5-amino-1H-tetrazole, dimethylpyrazole, and their derivatives. Among these compounds, the compound selected from the group consisting of azoles and its derivatives included in the polishing composition is preferably benzotriazole.

When the content of the compound selected from the group consisting of azoles and its derivatives in the polishing composition is less than 0.005% by mass, and more specifically less than 0.01% by mass, scratches formed on the surface of the magnetic disk substrate are not significantly reduced when the magnetic disk substrate is polished using the polishing composition. Therefore, in view of reducing scratches, the content of the compound selected from the group consisting of azoles and its derivatives in the polishing composition is preferably 0.005% by mass or more, and more preferably 0.01% by mass or more. Contrastingly, when the content of the compound selected from the group consisting of azoles and its derivatives in the polishing composition is greater than 1% by mass, and more specifically greater than 0.5% by mass, there is a risk that the protective film formed on the surface of the magnetic disk substrate by the compound selected from the group consisting of azoles and its derivatives could suppress polishing of the magnetic disk substrate. As a result, there is a risk that the removal rate of the magnetic disk substrate with the polishing composition could be decreased. Therefore, in view of preventing the removal rate from being decreased, the content of the compound selected from the group consisting of azoles and its derivatives in the polishing composition is preferably 1% by mass or less, and more preferably 0.5% by mass or less.

The preferred embodiment has the following advantages.

The polishing composition of the preferred embodiment includes the compound selected from the group consisting of azoles and its derivatives that reduces scratches formed on the surface of the magnetic disk substrate. Thus, according to this polishing composition, scratches formed on the surface of the magnetic disk substrate are reduced when the magnetic disk substrate is polished using the polishing composition. Furthermore, the polishing composition of the preferred embodiment includes the abrasive grain that plays the role of mechanically polishing the magnetic disk substrate and acid that plays the role of chemically polishing the magnetic disk substrate. According to this polishing composition, the magnetic disk substrate is polished at a high removal rate. Therefore, the preferred embodiment provides the polishing composition that is suitable for use in polishing the magnetic disk substrate.

The preferred embodiment may be modified as follows.

To the polishing composition of the preferred embodiment may be added a compound selected from a group consisting of sodium salt, potassium salt, and ammonium salt. When the compound selected from the group consisting of sodium salt, potassium salt, and ammonium salt is added to the polishing composition, scratches formed on the surface of the magnetic disk substrate are reduced when the magnetic disk substrate is polished using the polishing composition. This is presumed to be because the protective film is formed on the surface of the magnetic disk substrate by the compound selected from the group consisting of sodium salt, potassium salt, and ammonium salt. Among these compounds, potassium salt is preferably added to the polishing composition.

The compound selected from the group consisting of sodium salt, potassium salt, and ammonium salt added to the polishing composition may be salt of an organic acid such as citric acid, maleic acid, maleic anhydride, malic acid, glycolic acid, succinic acid, itaconic acid, malonic acid, gluconic acid, lactic acid, mandelic acid, tartaric acid, crotonic acid, nicotinic acid, acetic acid, adipic acid, formic acid, oxalic acid, methyl acid phosphate, ethyl acid phosphate, ethyl glycol acid phosphate, isopropyl acid phosphate, phytic acid, HEDP, and methanesulfonic acid, or salt of an inorganic acid such as orthophosphoric acid, pyrophosphoric acid, polyphosphoric acid, metaphosphoric acid, hexametaphosphoric acid, phosphonic acid, sulfonic acid, and sulfuric acid. Among these compounds, the compound selected from the group consisting of sodium salt, potassium salt, and ammonium salt added to the polishing composition is preferably phosphate, phosphonate, or citrate, and more preferably phosphate such as dipotassium hydrogen phosphate.

When the content of the compound selected from the group consisting of sodium salt, potassium salt, and ammonium salt in the polishing composition is less than 0.01% by mass, and more specifically less than 0.1% by mass, scratches formed on the magnetic disk substrate are not significantly decreased when the magnetic disk substrate is polished using the polishing composition. Therefore, in view of reducing the scratches, the content of the compound selected from the group consisting of sodium salt, potassium salt, and ammonium salt in the polishing composition is preferably 0.01% by mass or more, and more preferably 0.1% by mass or more. Contrastingly, when the content of the compound selected from the group consisting of sodium salt, potassium salt, and ammonium salt in the polishing composition is greater than 30% by mass, and more specifically greater than 10% by mass, there is a risk that the stability of the polishing composition could be reduced. Therefore, in view of preventing decrease of the stability of the polishing composition, the content of the compound selected from the group consisting of sodium salt, potassium salt, and ammonium salt in the polishing composition is preferably 30% by mass or less, and more preferably 10% by mass or less.

The polishing composition of the preferred embodiment may contain two or more types of abrasive grains.

The polishing composition of the preferred embodiment may contain two or more types of acids.

The polishing composition of the preferred embodiment may contain two or more types of compounds selected from the group consisting of azoles and its derivatives.

To the polishing composition of the preferred embodiment may be added a mildewproofing agent, an anticorrosive, an antifoaming agent, or a chelating agent if necessary.

The polishing composition of the preferred embodiment may be prepared by diluting an undiluted polishing composition with water.

Next, examples and comparative examples of the present invention will be described.

In examples 1 to 25 and comparative examples 1 to 18, colloidal silica, acid, the oxidizing agent, the compound selected from the group consisting of azoles and its derivatives, potassium salt, and water were mixed as required to prepare polishing compositions. Specifics of colloidal silica, acid, the oxidizing agent, the compound selected from the group consisting of azoles and its derivatives, and potassium salt in the polishing compositions of examples 1 to 25 and comparative examples 1 to 18 are as shown in Table 1.

The column entitled “Removal rate” in Table 1 represents results of evaluations for the removal rate calculated in accordance with the following equation when the magnetic disk substrates were polished under the following polishing conditions using the polishing compositions of examples 1 to 25 and comparative examples 1 to 18. In the column entitled “Removal rate”, 1 (excellent) represents that the removal rate was 0.1 μm/minutes or more, 2 (good) represents that the removal rate was 0.07 μm/minutes or more and less than 0.1 μm/minutes, 3 (slightly poor) represents that the removal rate was 0.04 μm/minutes or more and less than 0.07 μm/minutes, and 4 (poor) represents that the removal rate was less than 0.04 μm/minutes.

Polishing Conditions

Polishing object: ten magnetic disk substrates with a surface roughness Ra of 6 Åand a diameter of approximately 95 mm (3.5 inches) including an Ni—P electroless plating layer
Polishing machine: double sided polishing machine “SFDL-9B” manufactured by SPEEDFAM Co., Ltd.
Polishing pad: “FJM-01” manufactured by FILWEL Co., Ltd.
Polishing load: 7.8 kPa (80 g/cm²)
Rotation speed of lower surface plate: 30 rpm
Feed rate of polishing composition: 40 mL/minutes
Polishing time: 8 minutes
   Equation
   Removal rate [μm/minutes] =weight reduction amount of substrate by polishing [g]/(area of substrate [cm²]×density of nickel phosphorus plating [g/cm³]×polishing time [minutes]) ×10⁴

The column entitled “Scratches” in Table 1 represents the results of evaluations for the number of scratches on the magnetic disk substrates polished under the polishing conditions using the polishing compositions of examples 1 to 25 and comparative examples 1 to 18. In the column entitled “Scratches”, 1 (excellent) represents that the number of scratches measured using a nano defect visualizing macro inspection apparatus “MicroMax VMX 2100” manufactured by VISION PSYTEC Co. Ltd. was less than 20, 2 (good) represents that the number of scratches was 20 or more and less than 40, 3 (slightly poor) represents that the number of scratches was 40 or more and less than 60, and 4 (poor) represents that the number of scratches was 60 or more.

TABLE 1

| | Average particle | | | | | | |
|---|---|---|---|---|---|---|---|
| | size [nm] and | | Type and | Type and content [mass | Type and | | |
| | content [mass | Type and | content [mass | percentage] of a compound | content [mass | | |
| | percentage] of | content [mass | percentage] of an | selected from a group consisting | percentage] of | Removal | |
| | colloidal silica | percentage] of acid | oxidizing agent | of azoles and its derivatives | potassium salt | rate | Scratches |
| Ex. 1 | 20 nm | orthophosphoric acid | hydrogen peroxide | benzotriazole | K₂HPO₄ | 2 | 1 |
| | 5% | 1% | 0.62% | 0.1% | 0.8% | | |
| Ex. 2 | 10 nm | orthophosphoric acid | hydrogen peroxide | benzotriazole | K₂HPO₄ | 2 | 1 |
| | 5% | 2% | 0.62% | 0.1% | 0.8% | | |
| Ex. 3 | 20 nm | orthophosphoric acid | hydrogen peroxide | benzotriazole | K₂HPO₄ | 1 | 1 |
| | 5% | 2% | 0.62% | 0.1% | 0.8% | | |
| Ex. 4 | 40 nm | orthophosphoric acid | hydrogen peroxide | benzotriazole | K₂HPO₄ | 1 | 2 |
| | 5% | 2% | 0.62% | 0.1% | 0.8% | | |
| Ex. 5 | 20 nm | orthophosphoric acid | hydrogen peroxide | benzotriazole | K₂HPO₄ | 2 | 1 |
| | 5% | 2% | 0.62% | 0.5% | 0.8% | | |
| Ex. 6 | 20 nm | orthophosphoric acid | hydrogen peroxide | tolyltriazole | K₂HPO₄ | 1 | 1 |
| | 5% | 2% | 0.62% | 0.1% | 0.8% | | |
| Ex. 7 | 20 nm | orthophosphoric acid | hydrogen peroxide | 5-amino-1H- | K₂HPO₄ | 1 | 2 |
| | 5% | 2% | 0.62% | tetrazole | 0.8% | | |
| | | | | 0.1% | | | |
| Ex. 8 | 20 nm | orthophosphoric acid | hydrogen peroxide | dimethylpyrazole | K₂HPO₄ | 1 | 2 |
| | 5% | 2% | 0.62% | 0.1% | 0.8% | | |
| Ex. 9 | 20 nm | citric acid | hydrogen peroxide | benzotriazole | K₂HPO₄ | 2 | 1 |
| | 5% | 1% | 0.62% | 0.1% | 0.8% | | |
| Ex. 10 | 20 nm | maleic acid | hydrogen peroxide | benzotriazole | K₂HPO₄ | 1 | 2 |
| | 5% | 1% | 0.62% | 0.1% | 0.8% | | |
| Ex. 11 | 20 nm | malonic acid | hydrogen peroxide | benzotriazole | K₂HPO₄ | 1 | 1 |
| | 5% | 1% | 0.62% | 0.1% | 0.8% | | |
| Ex. 12 | 20 nm | malic acid | hydrogen peroxide | benzotriazole | K₂HPO₄ | 2 | 1 |
| | 5% | 1% | 0.62% | 0.1% | 0.8% | | |
| Ex. 13 | 20 nm | succinic acid | hydrogen peroxide | benzotriazole | K₂HPO₄ | 2 | 1 |
| | 5% | 1% | 0.62% | 0.1% | 0.8% | | |
| Ex. 14 | 20 nm | polyphosphoric acid | hydrogen peroxide | benzotriazole | K₂HPO₄ | 1 | 1 |
| | 5% | 1% | 0.62% | 0.1% | 0.8% | | |
| Ex. 15 | 20 nm | HEDP | hydrogen peroxide | benzotriazole | K₂HPO₄ | 1 | 1 |
| | 5% | 1% | 0.62% | 0.1% | 0.8% | | |
| Ex. 16 | 20 nm | methyl acid phosphate | hydrogen peroxide | benzotriazole | K₂HPO₄ | 1 | 1 |
| | 5% | 1% | 0.62% | 0.1% | 0.8% | | |
| Ex. 17 | 20 nm | citric acid | hydrogen peroxide | benzotriazole | — | 2 | 2 |
| | 5% | 1% | 0.62% | 0.1% | | | |
| Ex. 18 | 20 nm | maleic acid | hydrogen peroxide | benzotriazole | — | 1 | 2 |
| | 5% | 1% | 0.62% | 0.1% | | | |
| Ex. 19 | 20 nm | malonic acid | hydrogen peroxide | benzotriazole | — | 1 | 2 |
| | 5% | 1% | 0.62% | 0.1% | | | |
| Ex. 20 | 20 nm | malic acid | hydrogen peroxide | benzotriazole | — | 2 | 2 |
| | 5% | 1% | 0.62% | 0.1% | | | |
| Ex. 21 | 20 nm | succinic acid | hydrogen peroxide | benzotriazole | — | 2 | 2 |
| | 5% | 1% | 0.62% | 0.1% | | | |
| Ex. 22 | 20 nm | polyphosphoric acid | hydrogen peroxide | benzotriazole | — | 1 | 2 |
| | 5% | 1% | 0.62% | 0.1% | | | |
| Ex. 23 | 20 nm | HEDP | hydrogen peroxide | benzotriazole | — | 1 | 2 |
| | 5% | 1% | 0.62% | 0.1% | | | |
| Ex. 24 | 20 nm | methyl acid phosphate | hydrogen peroxide | benzotriazole | — | 1 | 2 |
| | 5% | 1% | 0.62% | 0.1% | | | |
| Ex. 25 | 20 nm | citric acid | hydrogen peroxide | benzotriazole | potassium | 2 | 1 |
| | 5% | 1% | 0.62% | 0.5% | citrate | | |
| | | | | | 0.04% | | |
| C. Ex. 1 | 20 nm | orthophosphoric acid | hydrogen peroxide | — | K₂HPO₄ | 2 | 3 |
| | 5% | 1% | 0.62% | | 0.8% | | |
| C. Ex. 2 | 20 nm | orthophosphoric acid | hydrogen peroxide | — | K₂HPO₄ | 1 | 3 |
| | 5% | 2% | 0.62% | | 0.8% | | |
| C. Ex. 3 | 20 nm | citric acid | hydrogen peroxide | — | K₂HPO₄ | 2 | 3 |
| | 5% | 1% | 0.62% | | 0.8% | | |
| C. Ex. 4 | 20 nm | citric acid | hydrogen peroxide | — | — | 2 | 4 |
| | 5% | 1% | 0.62% | | | | |
| C. Ex. 5 | 20 nm | maleic acid | hydrogen peroxide | — | — | 1 | 4 |
| | 5% | 1% | 0.62% | | | | |
| C. Ex. 6 | 20 nm | malonic acid | hydrogen peroxide | — | — | 1 | 4 |
| | 5% | 1% | 0.62% | | | | |
| C. Ex. 7 | 20 nm | malic acid | hydrogen peroxide | — | — | 2 | 4 |
| | 5% | 1% | 0.62% | | | | |
| C. Ex. 8 | 20 nm | succinic acid | hydrogen peroxide | — | — | 2 | 4 |
| | 5% | 1% | 0.62% | | | | |
| C. Ex. 9 | 20 nm | polyphosphoric acid | hydrogen peroxide | — | — | 1 | 4 |
| | 5% | 1% | 0.62% | | | | |
| C. Ex. 10 | 20 nm | HEDP | hydrogen peroxide | — | — | 1 | 4 |
| | 5% | 1% | 0.62% | | | | |
| C. Ex. 11 | 20 nm | methyl acid phosphate | hydrogen peroxide | — | — | 1 | 4 |
| | 5% | 1% | 0.62% | | | | |
| C. Ex. 12 | 20 nm | citric acid | hydrogen peroxide | — | potassium | 2 | 3 |
| | 5% | 1% | 0.62% | | citrate | | |
| | | | | | 0.04% | | |
| C. Ex. 13 | 20 nm | citric acid | — | benzotriazole | — | 4 | 2 |
| | 5% | 1% | | 0.1% | | | |
| C. Ex. 14 | 20 nm | orthophosphoric acid | — | benzotriazole | K₂HPO₄ | 4 | 2 |
| | 5% | 2% | | 0.1% | 0.8% | | |
| C. Ex. 15 | 20 nm | — | hydrogen peroxide | benzotriazole | K₂HPO₄ | 4 | 2 |
| | 5% | | 0.62% | 0.1% | 0.8% | | |
| C. Ex. 16 | 20 nm | — | hydrogen peroxide | benzotriazole | — | 4 | 3 |
| | 5% | | 0.62% | 0.1% | | | |
| C. Ex. 17 | 20 nm | citric acid | iron nitrate | — | — | 1 | 4 |
| | 5% | 1% | 10% | | | | |
| C. Ex. 18 | 20 nm | citric acid | iron nitrate | benzotriazole | — | 1 | 4 |
| | 5% | 1% | 10% | 0.1% | | | |

As shown in Table 1, practically sufficient results were obtained for the removal rate and the scratches in the polishing compositions of examples 1 to 25. In contrast, in comparative examples 1 to 18, practically sufficient results were not obtained for either the removal rate or the scratches.

Having described the preferred embodiment of the present invention, it is obvious to those skilled in the art that the present invention may be embodied in other particular forms without departing from the scope of the invention. The present invention is not limited to the illustrated embodiment but may be modified within the scope of the appended claims.

1. A polishing composition comprising abrasive grain, acid, an oxidizing agent, and a compound selected from a group consisting of azoles and its derivatives, wherein the polishing composition is used for polishing a magnetic disk substrate.

2. The polishing composition according to claim 1, wherein the compound selected from the group consisting of azoles and its derivatives includes at least one kind selected from a group consisting of benzotriazole, tolyltriazole, 5-amino-1H-tetrazole, dimethylpyrazole, and their derivatives.

3. The polishing composition according to claim 2, wherein the compound selected from the group consisting of azoles and its derivatives includes benzotriazole.

4. The polishing composition according to claim 1, wherein the content of the compound selected from the group consisting of azoles and its derivatives in the polishing composition is 0.005 to 1% by mass.

5. The polishing composition according to claim 1, wherein the abrasive grain includes silica.

6. The polishing composition according to claim 5, wherein the abrasive grain includes colloidal silica.

7. The polishing composition according to claim 1, wherein the average particle size of the abrasive grain is 0.005 to 1 μm.

8. The polishing composition according to claim 1, wherein the content of the abrasive grain in the polishing composition is 0.01 to 40% by mass.

9. The polishing composition according to claim 1, wherein the acid includes at least one kind of an organic acid selected from a group consisting of organic carboxylic acid, organic phosphonic acid, and organic sulfonic acid the number of carbons of which is 1 to 10.

10. The polishing composition according to claim 9, wherein the acid includes at least one kind selected from a group consisting of citric acid, maleic acid, maleic anhydride, malic acid, glycolic acid, succinic acid, itaconic acid, malonic acid, iminodiacetic acid, gluconic acid, lactic acid, mandelic acid, tartaric acid, crotonic acid, nicotinic acid, acetic acid, adipic acid, formic acid, oxalic acid, methyl acid phosphate, ethyl acid phosphate, ethyl glycol acid phosphate, isopropyl acid phosphate, phytic acid, 1-hydroxyethylidene-1,1-diphosphonic acid, and methanesulfonic acid.

11. The polishing composition according to claim 10, wherein the acid includes at least one kind of an organic acid selected from a group consisting of citric acid, maleic acid, malic acid, succinic acid, malonic acid, methyl acid phosphate, and 1-hydroxyethylidene-1,1-diphosphonic acid.

12. The polishing composition according to claim 11, wherein the acid includes an organic acid, which is at least either maleic acid or malonic acid.

13. The polishing composition according to claim 1, wherein the acid includes at least one kind of an inorganic acid selected from a group consisting of orthophosphoric acid, pyrophosphoric acid, polyphosphoric acid, metaphosphoric acid, hexametaphosphoric acid, phosphonic acid, sulfonic acid, and sulfuric acid.

14. The polishing composition according to claim 13, wherein the acid includes an inorganic acid, which is at least either orthophosphoric acid or polyphosphoric acid.

15. The polishing composition according to claim 1, wherein the content of the acid in the polishing composition is 0.01 to 40% by mass.

16. The polishing composition according to claim 1, wherein the oxidizing agent is hydrogen peroxide.

17. The polishing composition according to claim 1, wherein the content of the oxidizing agent in the polishing composition is 0.1 to 5% by mass.

18. The polishing composition according to claim 1, further comprising at least one kind of compound selected from a group consisting of sodium salt, potassium salt, and ammonium salt of an inorganic acid and an organic acid.

19. The polishing composition according to claim 18, wherein the at least one kind of compound selected from the group consisting of sodium salt, potassium salt, and ammonium salt of an inorganic acid and an organic acid is at least one kind of compound selected from a group consisting of phosphate, phosphonate, and citrate.

20. A polishing method of a magnetic disk substrate, comprising:
preparing a polishing composition containing abrasive grain, acid, an oxidizing agent, a compound selected from a group consisting of azoles and its derivatives; and
polishing the magnetic disk substrate using the polishing composition.
